(19) United States
(12) Patent Application Publication
(10) Pub. No.: US 2012/0198752 A1
(43) Pub. Date: Aug. 9, 2012

(54) Decoy Locomotion and Movement Device

(76) Inventor: James Lee Steinhausen, Lakewood, CO (US)

(21) Appl. No.: 13/367,370

(22) Filed: Feb. 6, 2012

Related U.S. Application Data
(60) Provisional application No. 61/462,527, filed on Feb. 4, 2011.

(51) Int. Cl. A01M 31/06

(52) U.S. Cl. 43/2

(57) ABSTRACT

The present invention is a decoy locomotion and movement device. A track is constructed having a T shaped slot running along the center line thereof. A transport runs along the track and utilizes a T shaped follower that fits inside the T slot. The transport moves along the track either by a user pulling it along with a cord or via powered components (such as a motor). Attached to the transport is a decoy shaped so as to attract a target animal or put it at ease. As the transport moves along the track, it appears to the target animal that the decoy is moving through the landscape. A secondary movement device is incorporated within the transport that causes an additional decoy movement to occur. Such movement can be lifting the head up and down, raising the wings up and down, wagging a tail side to side, etc.

### CROSS-REFERENCE TO RELATED APPLICATIONS

The application claims benefit of U.S. Provisional Application No. 61/462,527 entitled “Decoy-tracks” and filed on Feb. 4, 2011, which is specifically incorporated by reference herein for all that it teaches and discloses.

### TECHNICAL FIELD

The invention relates generally to animal confidence and/or attraction devices, and more specifically, to a device for decoy locomotion and movement.

### BACKGROUND

When humans attempt to study, photograph, watch, hunt, get close to, approach or otherwise observe and/or interact with animals (herein defined to including birds, fish, reptiles, and any other life forms), it is often helpful to employ one or more decoys in order to calm the subject animal and/or attract it. There are many known types and styles of decoys that can be employed. They vary across a wide spectrum of forms, shapes, sizes, etc. However, most decoys generally fall into two categories: confidence decoys (such as a blue heron decoy used near duck decoys or a duck blind) that are used to calm the subject animals (in this case ducks or geese), and attraction decoys (such as duck decoys) that are used to attract the subject animals. As another example, when attempting to hunt turkeys, one or more turkey decoys will help attract turkeys to a specific location while a doe deer feeding decoy placed nearby may help to calm any turkeys by making them believe that the specific location is safe if a deer is willing to calmly feed in the area. When used in a hunting scenario, attraction decoys are usually the more popular type of decoy, but both types can be used in such scenarios as well. Similarly, photographers, videographers, biologists, ornithologists, artists, amateur animal watchers, and many others have found that using attraction and/or confidence decoys can help them get close to animals.

Historically, decoys were often crude affairs that generally approximated the animal that was to be attracted. However, currently known decoys are a great improvement upon those early decoys and many are now quite realistic in appearance. Nevertheless, wary subject animals have often learned to be cautious and not be fooled by inert decoys that sit in one location and do not move, regardless of how realistic they otherwise appear. Somewhat recently, waterfowl hunters have attempted to address this deficiency in decoys by incorporating movement devices thereon. Examples include: duck decoys with rotating wings meant to replicate the appearance of landing waterfowl, decoys that tip downwards to replicate the appearance of feeding waterfowl, decoys that swim in circles to replicate the appearance of swimming waterfowl, etc. Such moving decoys have significantly enhanced the average effectiveness of a grouping of decoys in attracting live ducks to a specific location.

Despite the enhanced attractiveness shown by moving decoys employed to attract waterfowl, those wishing to attract other subject animals have been slow to develop moveable land-based decoys. Predatory animal hunters/photographers/etc. have begun employing vibrating or erratically ‘flopping’ prey animal simulators/decoys, but such generally are confined to a single location and do not move across the landscape. Deer, antelope, elk, and turkey decoys are usually staked in a single location, and although they sometimes can turn in the wind (or by the use of a jerk line), they do not move from the single location at which they are initially placed.

Thus, there remains a need for a decoy locomotion and movement device that can work with existing and/or improved decoys to cause them to move across the landscape. Such a device can also incorporate additional movement actuators to further enhance the lifelike appearance of decoys.

### SUMMARY

One embodiment of the present invention comprises a track and a transport. The track can be constructed such that a user of the invention can configure the track into a custom layout in order to guide the locomotion of the transport across the landscape in the specific direction(s) desired by the user. In another embodiment, the track provides a pre-determined fixed pathway along which the transport moves. The transport is guided along the track by a track follower that interacts with the track to ensure that the transport stays in proximity to the track during its motion across the landscape.

The transport incorporates a decoy retainer that provides a means for a decoy to be attached to the transport or otherwise remain in close proximity to the transport such that as the transport moves along the track, the decoy moves along the track as well. In another embodiment, the transport also incorporates at least a secondary decoy movement device that cause one or more parts of the decoy to move in addition to the general locomotion of the decoy in proximity to the track.

In a customizable track, the track can be configured in a loop or some other continuous shape; alternatively, the track can have one or more end points. End points can cause the transport to stop its locomotion and/or to reverse the direction of its locomotion. To enhance realism, when a decoy reaches an end point it is preferred that a secondary decoy movement be triggered before the decoy reverses direction. In such a case, the preferred secondary decoy movement is to turn the decoy such that it faces the direction of forward travel before the decoy begins to move in the new direction.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a left side elevation view of an exemplary embodiment of a decoy locomotion and movement device;

FIG. 2 illustrates a front elevation view of an exemplary embodiment of a decoy locomotion and movement device;

FIG. 3 illustrates a front elevation view of an exemplary embodiment of a decoy locomotion and movement device with the main body removed to better illustrate an embodiment of internal locomotion and movement components;

FIG. 4 illustrates a top plan view of an exemplary embodiment of decoy track components showing a straight track component, a forty-five degree angle track component, a ninety degree angle track component, and a loop track component;

FIG. 5 illustrates a side elevation view of an exemplary embodiment of a first decoy showing a head in the up position and a second decoy showing a head in the down position;

FIG. 6 illustrates a side elevation view of an exemplary embodiment of a first decoy showing a pair of wings in an exemplary up position and a second decoy showing a pair of wings in an exemplary down position; and

FIG. 7 illustrates a rear elevation view of an exemplary embodiment of a first decoy showing a tail in an exemplary down position and a second decoy showing a tail in an exemplary up position.

### DETAILED DESCRIPTION

Referring now to the drawings, exemplary embodiments of the invention are described below in the accompanying Figures. The following detailed description provides a comprehensive review of the drawings in order to provide a thorough understanding of, and an enabling description for, these embodiments. One having ordinary skill in the art will understand that the invention may be practiced without certain details. In other instances, well-known structures and functions have not been shown or described in detail to avoid unnecessarily obscuring the description of the embodiments.

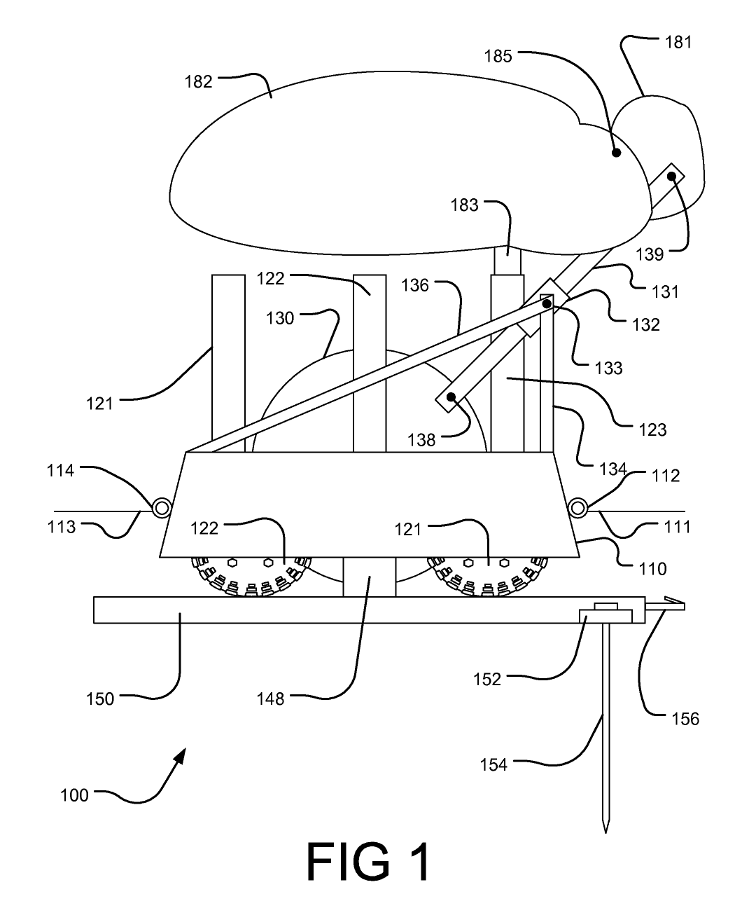

FIG. 1 shows a left side elevation view of an exemplary embodiment of a decoy locomotion and movement device 100. The transport 105 has a main body 110 that is shown in a box like configuration in the embodiment illustrated in FIG. 1, other shapes and styles are contemplated. It is preferred for the transport 105 to be relatively short in height and camouflaged in color so as to be less visible to the subject animal.

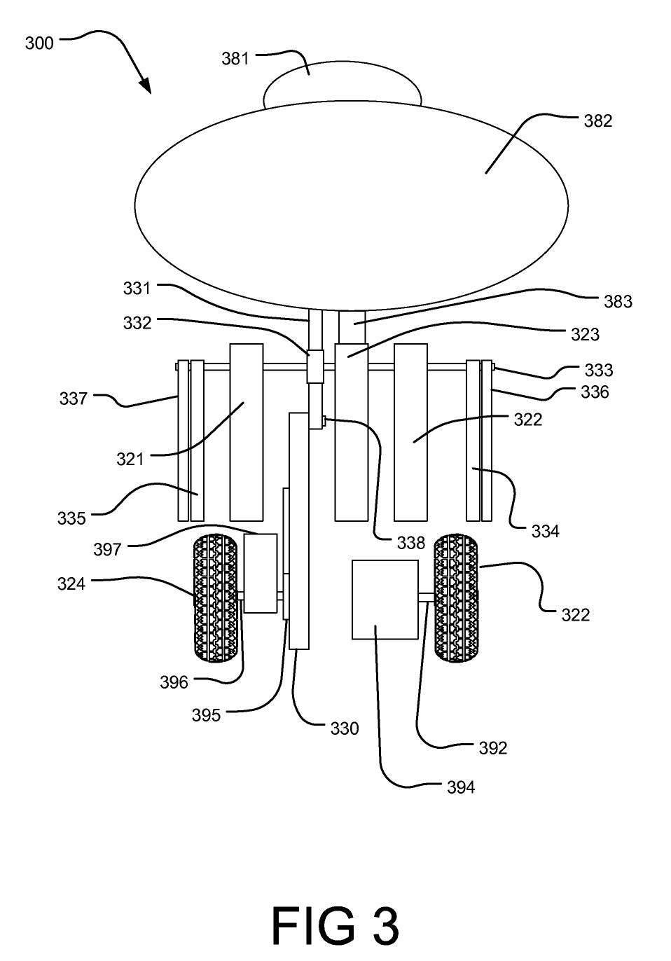

Attached to the main body 110 are the first pull anchor 112 and the second pull anchor 114. In one embodiment, an internal source of power such as a battery and electronics are used to move the device 100 (see FIG. 3 for more details). In another embodiment, the first pull anchor 112 and the second pull anchor 114 are used in combination with a first pull cord 111 and a second pull cord 113 attached to each pull anchor, respectively. The first pull cord 111 can be manually pulled by the user in order to move the device in a first direction, and then the second pull cord can be pulled to move the device in a second direction (preferably opposite that of the first direction).

The transport 105 in the embodiment illustrated in FIG. 1 has a plurality of wheels 121 and 122 (in other embodiments, more or fewer wheels can be used). The wheels 121 and 122 are attached to the main body 110 and rest upon the track component 150. If the device is manually pulled along the track 150, this causes the wheels 121 and 122 to turn. If instead the internal power source and electronics are used to move the transport 105, then they cause the wheels to turn and that creates the locomotive force necessary to move the transport 105 along the track 150. In another embodiment, the power source is external (such as a battery or other source of electricity powering a rail or ‘hot’ wire running through the tracks).

The follower 148 extends from the transport 105 generally downwards into proximity with the track 150. In a preferred embodiment, the follower 148 is configured so as to keep the transport 105 generally centered on the track 150 as it moves along.

As the transport 105 moves along the track 150, the wheels 121 and 122 turn in a generally circular motion. At least one wheel 122 is in mechanical communication with the secondary motivator 130 such that as the at least one wheel 122 turns it causes the secondary motivator 130 to turn as well. The mechanical communication can be gears, pulleys, belts, screw drives, combinations thereof or other mechanical means for transferring motion between two objects as known in the art. As the secondary motivator 130 spins in a generally circular motion, the actuator pin 138 describes a circle relative to the transport 105. Attached to the actuator pin 138 is a first transfer bar 131. Because the first transfer bar 131 is restrained by the transfer bar sleeve 132, the first transfer bar 131 is pulled in and out through the sleeve 132 as the secondary motivator 130 spins. In an alternate embodiment, if an internal power source and electronics are utilized, the mechanical communication between the wheels and the secondary motivator becomes unnecessary as a second set of electronics can be used to activate the in and out motion of the first transfer bar 131.

At the distal end of the first transfer bar 131, the bar 131 is attached to an appendage portion 181 of a decoy via an appendage attachment means 139. The appendage attachment means 139 as illustrated in FIG. 1 is a simple pin that is affixed to the appendage 181 and the first transfer bar 131 attaches to the pin but is allowed to rotate relative to the pin in order to accommodate the motion of the first transfer bar 131 and the decoy appendage 181. In FIG. 1, the decoy body 182 is shown as is an appendage 181. Although not specifically visible in FIG. 1, the two decoy components can be attached to one another in a hinged configuration so that the appendage 181 can move relative to the decoy body 182. The appendage 181 can be any portion of a decoy such as a head, tail, wing, leg, etc. As the transfer bar 131 moves in and out of the sleeve 132, it causes the appendage 181 to move relative to the decoy body 182. For more details concerning exemplary appendages and desirable motions thereof see later drawing Figures.

The sleeve 132 is attached to the cross member 133 so that it is generally fixed in location relative to the main body 110. However, the sleeve 132 is allowed to rotate relative to the cross member 133 to accommodate the motion of the first transfer bar 131.

The decoy body 182 can be mounted on the transport 105 by a mounting block 183. The mounting block allows attachment of the decoy to one or more of the plurality of mounting points 121, 122 and 123. As shown in FIG. 1, the plurality of mounting points 121, 122 and 123 are generally vertically arranged, hollow cylinders attached to the main body 110. The mounting points 121, 122 and 123 are configured to allow for one or more mounting blocks 183 to be attached thereto. Although not shown in FIG. 1, a pin, clip, or similar device can be used to lock the mounting block 183 to the mounting point 123. Any means can be used to attach the decoy body 182 to the mounting block 183. A plurality of mounting points 121, 122 and 123 allow for various styles, sizes, and kinds of decoys to be used on a single universal transport 105.

The cross support 136 is a support member that helps to provide support and rigidity to the cross member 133. Similarly, the vertical support 134 also provides support and rigidity to the cross member 133. Both the cross support 136 and the vertical support 134 can be replaced with other shaped and sized components in other configurations as many different types of supports and configurations thereof could fulfill the function of supporting the cross member 133 relative to the main body 110.

The track 150 can have a plurality of track supports 152 which removably attach to the track 150 (or are integrally formed with the track) and provide for attachment of at least one track stabilizer 154. The track stabilizer 154 illustrated in FIG. 1 comprises a spike which can be driven into the ground upon which the track 150 is resting in order to secure the track 150 to the ground. A track connector means 156 is also illustrated in FIG. 1. Any of a myriad of known connector means can be utilized to secure track components 150 to one another. The exemplary track connector means 156 illustrated in FIG. 1 is a tab and lock. To attach track components 150 to one another, the user simply inserts the tab from a first track component 150 into a slot in another track component and the lock pops up and locks the two pieces of track to one another. To detach the two pieces of track, the user simply presses down on the lock and then slides the tab out of the slot and disconnects the track pieces. In other embodiments, other track connector means 156 are contemplated.

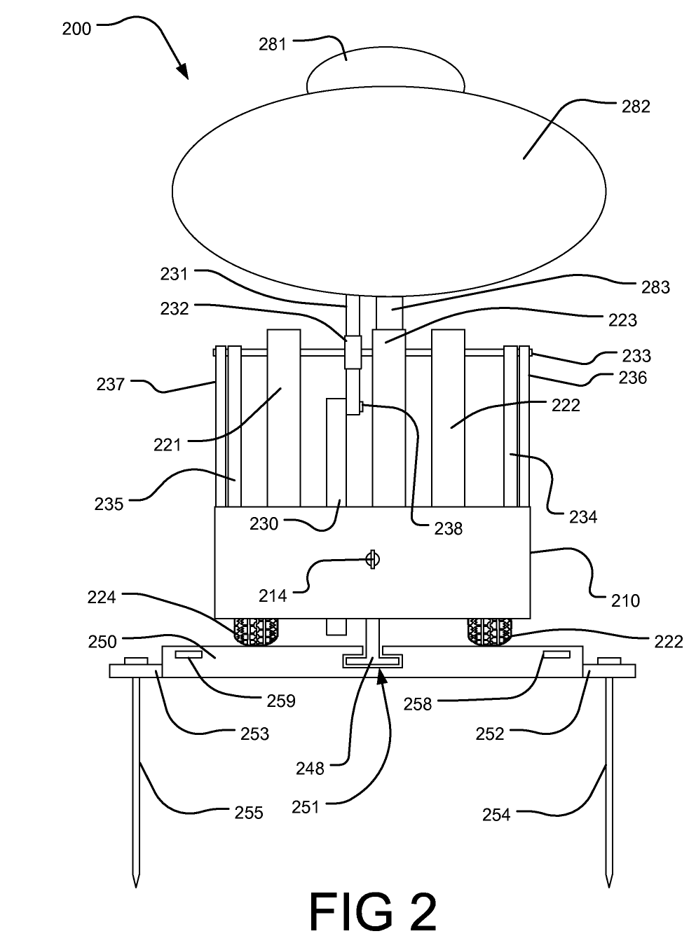

FIG. 2 illustrates a front elevation view of an exemplary embodiment of a decoy locomotion and movement device 200. The components shown in FIG. 2 are similar to those in FIG. 1. There are, however, a number of components that are more easily discernible in the view of FIG. 2. For example, the shape of an exemplary follower 248 can be seen more clearly in FIG. 2. The follower 248 can be generally shaped to resemble a “T”. Similarly, a T slot 251 can be formed in the body of the track 250 and running generally parallel with the length of the track. As the follower 248 is attached to the main body 210, as the transport 205 moves along the track 250, the follower 248 is contained in the T slot 251 thereby assuring that the transport 205 stays in closes proximity to the track 250.

Additional track supports 252 and 253 are illustrated in FIG. 2 as are track stabilizers 254 and 255. Two attachment slots 258 and 259 are also shown. These slots accept the attachment tabs (see FIG. 1 where a single attachment tab 156 is illustrated).

FIG. 3 illustrates a front elevation view of an exemplary embodiment of a decoy locomotion and movement device 300 with the main body removed to better illustrate one embodiment of internal locomotion and movement components. The first wheel 322 has a first axle 392 attached to a first motivator 394 which helps to attach and stabilize the first wheel 322 to the main body as well as causing the wheel to turn in response to directions from control electronics (not shown in FIG. 3 as control electronics such as circuit boards, chips, wireless transmitters, programs, etc. are known in the art and can be easily configured by one skilled in the art to control the direction and speed of wheel turning based on user desires). As the first wheel turns, the transport 305 is caused to move along the track in response thereto.

The second wheel 324 is attached to a second axle 396 and a second motivator 397 which can turn the wheel similar to that described for the first motivator, and/or it can serve as an attachment support point to attach the second wheel 324 to the transport 305. The second axle 396 can be in mechanical communication with a mechanical actuator means 395. As the second wheel 324 turns, the second axle can be caused to turn as well which causes the mechanical actuator means 395 to turn and impart circular motion to the secondary motivator 330. As described in detail under FIG. 1, the circular motion of the secondary motivator 330 causes the first transfer bar 331 to move in and out through the sleeve 332. And as the transfer bar 331 is attached to the appendage 381, the appendage 381 is forced to move relative to the decoy body 382. As discussed above, if an internal power source and electronics are utilized, the mechanical communication between the second wheel 324 and the secondary motivator 330 is unnecessary as a second electronic motor/actuator can impart the desired motion to the appendage 381.

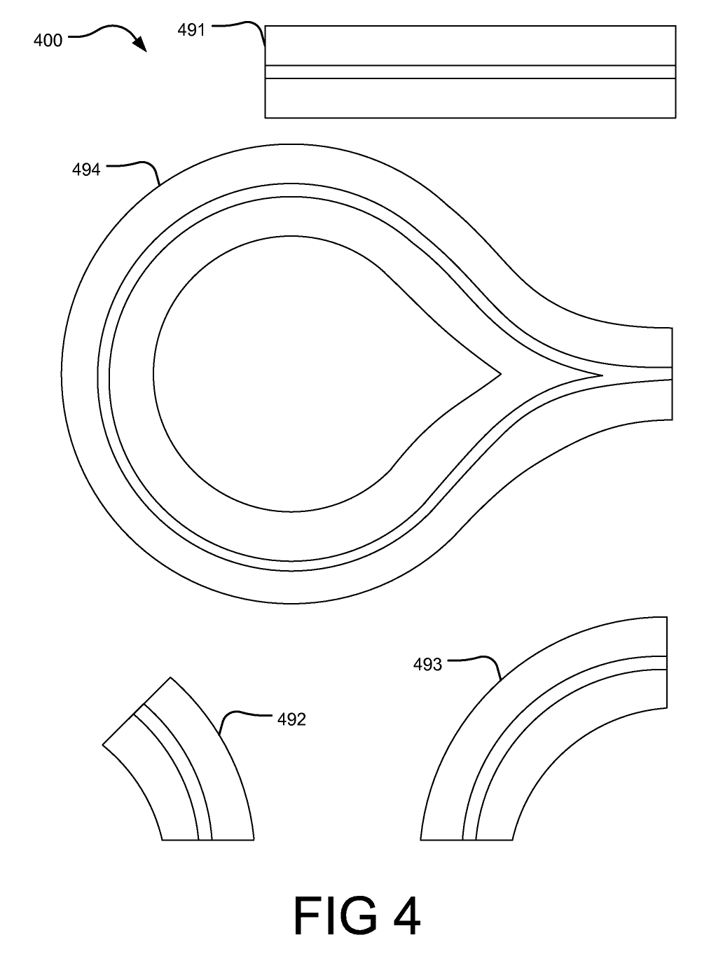

FIG. 4 illustrates a top plan view of an exemplary embodiment of decoy track components 400 showing a straight track component 491, a forty-five degree angled track component 492, a ninety degree angle track component 493, and a loop track component 494. The various track components 491, 492, 493 and 494 can be attached to one another in any desired configuration in order to create the track layout needed by the user. For example, four ninety degree components 493 can be attached to one another to form a circle; four ninety degree components 493 can be attached together with four straight components 491 between each ninety degree component 493 to form a rounded-corner square; multiple straight components 491 can be attached together to form a single long runway; a loop component 494 can be attached at each end of a string of straight components 491 to create a runway with a turnaround at each end; various forty five degree angle track components 492 can be combined in an alternating manner to create a wavy runway; etc. The combinations are almost limitless given enough sections of each type of track.

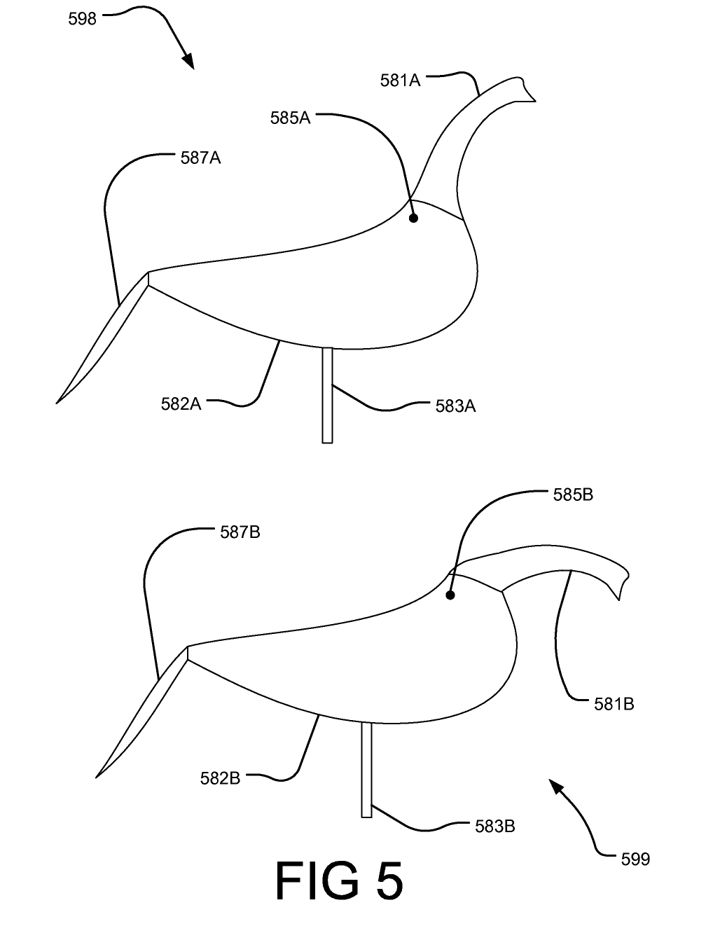

FIG. 5 illustrates a side elevation view of an exemplary embodiment of a first decoy 598 showing a head in the up position 581A and a second decoy 599 showing a head in the down position 581B. Other components include a first tail 587A, a second tail 587B, a first body 582A and a second body 582B. The decoys 598 and 599 also have a first mounting block 583A and a second mounting block 583B. Although not shown in FIG. 5, the transfer bar from the transport extends preferably up inside the body of the decoy 582 and attaches to the base of the head 581 opposite the head hinge pin 585. When the head is in the up position (see the first decoy 598 and first head 581A), the transfer bar is in its most extending position. Then, when the secondary movement components cause the transfer bar to be withdrawn somewhat downwards, this causes the head to be pulled downwards and it rotates against the head hinge pin 585. As the second movement components cause the transfer bar to cycle slowly up and down, the head in turn moves slowly from the up position of the first decoy 598 into the down position of the second decoy 599 and then back again.

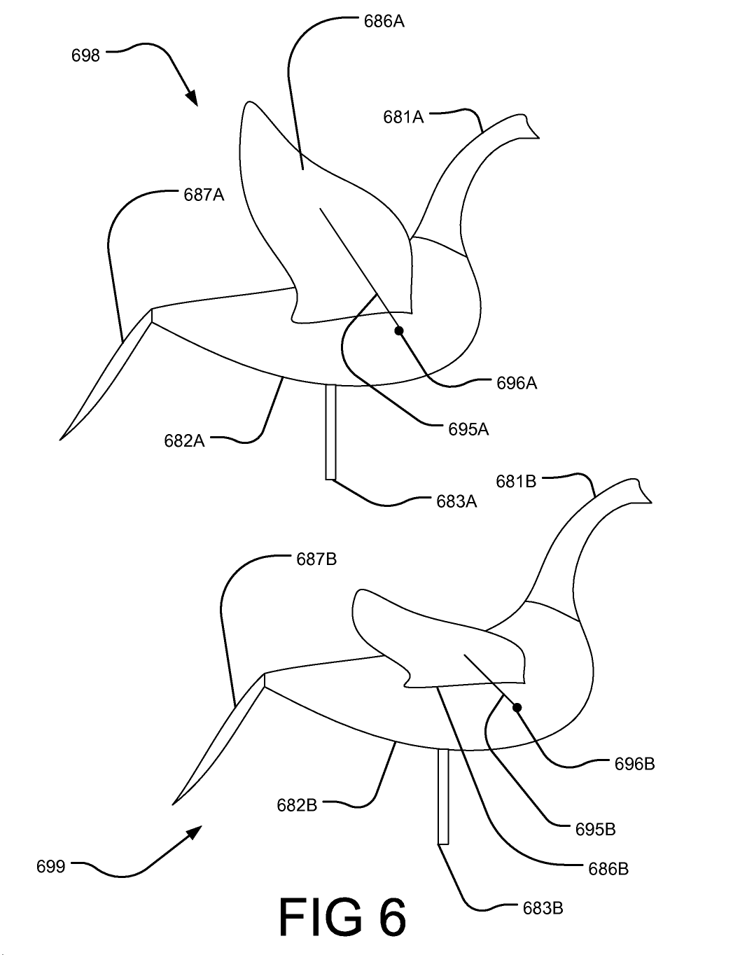

FIG. 6 illustrates a side elevation view of an exemplary embodiment of a first decoy 698 showing wings 686A in an exemplary up position and a second decoy 699 showing wings 686B in an exemplary down position. Also illustrated are a first decoy head 681A, a second decoy head 681B, a first pulley actuator 696A, a second pulley actuator 696B, a first wing connector 695A, a second wing connector 695B, a first body 682A, a second body 682B, a first tail 687A, a second tail 687B, a first mounting block 683A and a second mounting block 683B.

Not that the secondary movement illustrated in FIG. 6 is moving the wing 686 in an up and down manner. To accomplish this, wing connector 695 is connected via a pulley actuator to the transfer bar (not shown in FIG. 6, but preferably located inside the decoy body). The transfer bar can be configured to extend well above and past the location of the pulley actuator 696 in a line between the actuator 696 and the base of the head 681. If the wing connector 695 comprises a string or cord of some type, it can be affixed at one end to the wing 686, threaded through the pulley actuator 696 and connected to the upper end of the transfer bar. The wing 686 can then be spring loaded such that it is in the up position when at rest (e.g., when the transfer bar retracts to its most minimum distance inside the body of the decoy). Then, when the transfer bar cycles up into its maximum extension into the body of the decoy, it pulls the wing connector 695 through the pulley actuator 696 causing the wing to be forced downwards into a down position. It should be obvious to one skilled in the art to make the necessary adjustments and configurations to implement the above mechanizations for a decoy having a wing on each side of the body.

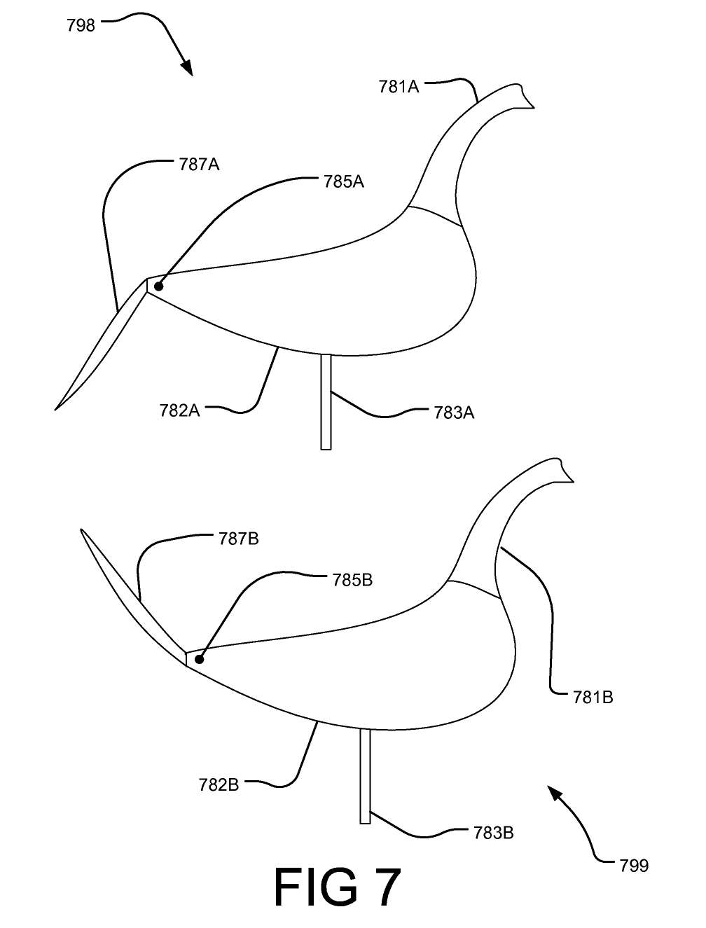

FIG. 7 illustrates a side elevation view of an exemplary embodiment of a first decoy 798 showing a first tail 787A in an exemplary down position and a second decoy 799 showing a second tail 787B in an exemplary up position. Other illustrated components include the first and second decoy bodies 782A and 782B, the first and second decoy heads 781A and 781B, the first and second mounting blocks 783A and 783B, and first and second tail hinge pins 785A and 785B. As in the decoys shown in FIG. 5, the secondary movement components can cause the tail to move up and down and cycle between the positions shown in FIG. 7. Here, the hinge pin 785 is located near the tail 787 and provides the hinge about which the tail is forced up and down as the transfer bar moves up and down. Similarly, by the simple addition or modification of some of the mechanical linkages, the tip of the tail could be causes to swing side to side as another type of secondary movement.

Although not shown, a second transfer bar could also be incorporated such that both the head and the tail move up and down concurrently. In another embodiment, the head, tail and wings could all move concurrently, or some combination of secondary movements could occur.

As discussed above, the secondary movement(s) could be controlled using mechanical linkages that are driven by the movement of one or more of the wheels turning as the transport moves on the track. Alternatively, secondary movement(s) could have individual motors/actuators that drive each one. Such independent motors/actuators could be triggered by ‘trigger spots’ placed along the track that are sensed as the transport moves past them and they can activate one or more of the motors/actuators and cause one or more of the secondary movements to initiate. Similarly, small protrusions could be added to the top or side of the track and a mechanical protrusion sensing component could displace when it bumps into the protrusions, triggering the one or more secondary movements to take place. In another embodiment, the user sends a signal (either via a wire or wirelessly) to the transport causing the secondary movement(s) to occur. In yet another embodiment, the user can manually activate a secondary input by pulling on a secondary movement cord that is attached to the transfer bar (either directly or indirectly) and causing the transfer bar to move, thus initiating the secondary movement(s) manually.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. A decoy locomotion and movement device comprising:
a track comprising multiple track components that can be connected together to form the track, wherein each track component has a T shaped slot running generally along a center line of the track component such that when multiple track components are attached to one another a single, continuous T slot is formed;
a plurality of track supports removably attached to the track and providing a means for attachment of a track stabilizer thereto, the track stabilizer configured to removably attach the track support to a fixed structure such as a surface of a field;
a transport comprising a plurality of wheels attached to a main body such that the plurality of wheels is in contact with the track and can rotate as the transport moves along the track;
a T follower attached to the transport and configured so as to glide within the T slot of the track as the transport moves along the track;
a secondary motivator generally disc shaped and affixed in position on the transport such that it does not move in position relative to the transport but that it can rotate about a center axis, and wherein the secondary motivator is mechanically attached to at least one of the plurality of wheels such that rotation of the wheel causes the secondary motivator to rotate as well;
a transfer bar having a proximal end and a distal end, the proximal end rotatably attached near an outside perimeter of the secondary motivator and configured to slide within a sleeve, the sleeve attached to the transport so that the sleeve can rotate about at least one axis thereby allowing the transfer bar to slide in and out of the sleeve without binding as the secondary motivator rotates;
a decoy attachment means attached at the distal end of the transfer bar and configured to also be attached to a decoy appendage such that as the transfer bar moves in and out of the sleeve the transfer bar can cause the decoy appendage to have a motion as well;
a decoy mounting block configured to removably attach to a decoy and to also removably attach to a plurality of decoy mounting points, whereby the plurality of decoy mounting points are attached to the transport;
a first pull anchor attached to a front of the main body and a second pull anchor attached to a back of the main body, a first cord attached to the first pull anchor and a second cord attached to the second pull anchor such that a user can pull on the first pull cord to move the transport forward along the track and the user can pull on the second pull cord to move the transport backward along the track; and
wherein as the transport is moved along the track, the plurality of wheels rotate and the secondary motivator rotates causing the transfer bar to move in and out thereby moving the decoy appendage.

2. The decoy locomotion and movement device of claim 1 wherein the multiple track components include at least a straight track component.

3. The decoy locomotion and movement device of claim 1 wherein the multiple track components include at least a ninety degree angle track component that is configured so as to cause the transport to turn ninety degrees as the transport moves over the ninety degree angle track component.

4. The decoy locomotion and movement device of claim 1 wherein the multiple track components include at least a loop track component, the loop track component having a single inbound track and a circular loop that runs from the single inbound track out into a loop and back to the single inbound track.

5. The decoy locomotion and movement device of claim 2 wherein the multiple track components include at least a ninety degree angle track component that is configured so as to cause the transport to turn ninety degrees as the transport moves over the ninety degree angle track component.

6. The decoy locomotion and movement device of claim 2 wherein the multiple track components include at least a loop track component, the loop track component having a single inbound track and a circular loop that runs from the single inbound track out into a loop and back to the single inbound track.

7. The decoy locomotion and movement device of claim 5 wherein the multiple track components include at least a loop track component, the loop track component having a single inbound track and a circular loop that runs from the single inbound track out into a loop and back to the single inbound track.

8. The decoy locomotion and movement device of claim 1 wherein the multiple track components have at least one track attachment slot and at least one track attachment tab, the slot and tab configured to releaseably attach each track component to other track components.

9. A decoy locomotion and movement device comprising:
a track comprising multiple track components that can be connected together to form the track, wherein each track component has a T shaped slot running generally along a center line of the track component such that when multiple track components are attached to one another a single, continuous T slot is formed;
a plurality of track supports removably attached to the track and providing a means for attachment of a track stabilizer thereto, the track stabilizer configured to removably attach the track support to a fixed structure such as a surface of a field;
a transport comprising a plurality of wheels attached to a main body such that the plurality of wheels is in contact with the track and can rotate as the transport moves along the track;
a T follower attached to the transport and configured so as to glide within the T slot of the track as the transport moves along the track;
a secondary motivator generally disc shaped and affixed in position on the transport such that it does not move in position relative to the transport but that it can rotate about a center axis, and wherein the secondary motivator is mechanically attached to at least one of the plurality of wheels such that rotation of the wheel causes the secondary motivator to rotate as well;
a transfer bar having a proximal end and a distal end, the proximal end rotatably attached near an outside perimeter of the secondary motivator and configured to slide within a sleeve, the sleeve attached to the transport so that the sleeve can rotate about at least one axis thereby allowing the transfer bar to slide in and out of the sleeve without binding as the secondary motivator rotates;
a motor attached to the main body and configured to power the turning of at least one of the plurality of wheels;
a decoy attachment means attached at the distal end of the transfer bar and configured to also be attached to a decoy appendage such that as the transfer bar moves in and out of the sleeve the transfer bar can cause the decoy appendage to have a motion as well;
a decoy mounting block configured to removably attach to a decoy and to also removably attach to a plurality of decoy mounting points, whereby the plurality of decoy mounting points are attached to the transport;
the motor being able to be activated by a user and thereby causing the transport to move along the track; and
wherein as the transport moves along the track, the plurality of wheels rotate and the secondary motivator rotates causing the transfer bar to move in and out thereby moving the decoy appendage.

10. The decoy locomotion and movement device of claim 9 wherein the multiple track components include at least a straight track component.

11. The decoy locomotion and movement device of claim 9 wherein the multiple track components include at least a ninety degree angle track component that is configured so as to cause the transport to turn ninety degrees as the transport moves over the ninety degree angle track component.

12. The decoy locomotion and movement device of claim 9 wherein the multiple track components include at least a loop track component, the loop track component having a single inbound track and a circular loop that runs from the single inbound track out into a loop and back to the single inbound track.

13. The decoy locomotion and movement device of claim 10 wherein the multiple track components include at least a ninety degree angle track component that is configured so as to cause the transport to turn ninety degrees as the transport moves over the ninety degree angle track component.

14. The decoy locomotion and movement device of claim 13 wherein the multiple track components include at least a loop track component, the loop track component having a single inbound track and a circular loop that runs from the single inbound track out into a loop and back to the single inbound track.

15. A decoy locomotion and movement device comprising:
a track comprising multiple track components that can be connected together to form the track, wherein each track component has a T shaped slot running generally along a center line of the track component such that when multiple track components are attached to one another a single, continuous T slot is formed;
a plurality of track supports removably attached to the track and providing a means for attachment of a track stabilizer thereto, the track stabilizer configured to removably attach the track support to a fixed structure such as a surface of a field;
a transport comprising a plurality of wheels attached to a main body such that the plurality of wheels is in contact with the track and can be in a rotation as the transport moves along the track;
a motor attached to the main body and configured to power the rotation of at least one of the plurality of wheels;
the motor being able to be activated by a user and thereby causing the transport to move along the track;
a T follower attached to the transport and configured so as to glide within the T slot of the track as the transport moves along the track;
a secondary motivator affixed in position on the transport such that it does not move in position relative to the transport, and configured so that it can be activated by external input;
a transfer bar having a proximal end and a distal end, the proximal end attached to the secondary motivator and configured to move when the secondary motivator is activated;
a decoy attachment means attached at the distal end of the transfer bar and configured to also be attached to a decoy appendage such that as the transfer bar moves the transfer bar can cause the decoy appendage to have a motion as well;
a decoy mounting block configured to removably attach to a decoy and to also removably attach to a plurality of decoy mounting points, whereby the plurality of decoy mounting points are attached to the transport; and
wherein the user controls movement of the transport along the track and can control activation of the secondary motivator to move the decoy appendage.

16. The decoy locomotion and movement device of claim 15 wherein the multiple track components include at least a straight track component.

17. The decoy locomotion and movement device of claim 15 wherein the multiple track components include at least a ninety degree angle track component that is configured so as to cause the transport to turn ninety degrees as the transport moves over the ninety degree angle track component.

18. The decoy locomotion and movement device of claim 15 wherein the multiple track components include at least a loop track component, the loop track component having a single inbound track and a circular loop that runs from the single inbound track out into a loop and back to the single inbound track.

19. The decoy locomotion and movement device of claim 16 wherein the multiple track components include at least a ninety degree angle track component that is configured so as to cause the transport to turn ninety degrees as the transport moves over the ninety degree angle track component.

20. The decoy locomotion and movement device of claim 19 wherein the multiple track components include at least a loop track component, the loop track component having a single inbound track and a circular loop that runs from the single inbound track out into a loop and back to the single inbound track.
